(19) United States
(12) Patent Application Publication
(10) Pub. No.: US 2023/0169539 A1
(43) Pub. Date: Jun. 1, 2023

(54) METHOD AND SYSTEM FOR ADVERTISING CONTENT DEMONSTRATION MANAGEMENT

(71) Applicant: Addreality Global Limited, Wanchai (HK)

(72) Inventors: Rekish ALEKSEI, Saint-Petersburg (RU); Galeev SERGEI, Saint-Petersburg (RU)

(73) Assignee: Addreality Global Limited, Wanchai (HK)

(21) Appl. No.: 17/535,828

(22) Filed: Nov. 26, 2021

(51) Int. Cl. G06Q 30/02

(52) U.S. Cl. CPC G06Q 30/0254; G06Q 30/0246; G06Q 30/0269

(57) ABSTRACT

System/method for advertising content demonstration management preforming compilation of a set of rules for advertising content demonstration, and a corresponding set of advertising materials; saving of the set of advertising materials in a database; scanning of visitors around a broadcasting unit, by means of a visitor's data acquisition device; recognition and classifying of visitors according to data acquired, taking into account information from external data sources; selecting a rule from a set of the rules for advertising content demonstration, which coincides the most closely to the results of said classification, taking into account information from external data source; demonstration of advertising materials corresponding to a selected rule; registering of viewings of advertising materials by a visitor by means of at least one visitor's data acquisition device; saving information about viewings in the database; and compilation of a report about accomplishment of planned demonstration quantitative targets specified in an application.

### TECHNICAL FIELD

The present group of inventions belongs to the field of management of demonstration of advertising content stored on data carriers at sales areas, entertainment centers, sporting event zones, and other places of human traffic gathering. The present group of inventions allows to track and analyze sales area visitor's behavior for stimulation of customer demand. The present group of inventions allows to demonstrate advertising offers, which are in real time adapted to a specific viewer and personalized according to age-sex characteristics, mood, movement trajectory through the sales area, etc.

### Relevance

Nowadays interactive advertising at sales areas, in shopping malls and other places of gathering of visitors' streams (human traffic) is more and more actively forcing out traditional static signboards and billboards. It is related to a common trend to personification of advertising, which in the recent years has been seen both in on-line and brick-and-mortar retail. Retail is characterized by high competition, that is why attracting new customers and their loyalty management is one of key and complicated tasks in this sector. Interactive advertising allows to solve this problem by demonstration of target advertisements and personalized offers optimized for a specific viewer (potential customer).

Nowadays personification of the content of advertising offers (content) is a common phenomenon for on-line retail. Advertising in on-line domain is adapted to a certain user in a real-time mode, based on his or her browser history, previous and current purchases in on-line shops, subscription to certain groups or resources on the Internet, behavior typical for a certain group of people with similar age-sex characteristics, interests, and recognized audio data from mobile phone microphones. Such a powerful advantage of on-line retail creates an unbalanced competitiveness over brick-and-mortar shops due to reduction of marketing effort conversion of the last and rise of customer outflow to on-line marketplaces. Although brick-and-mortar retail still has a major part of all retail purchases, the percentage of on-line retail in the overall retail demonstrates annual growth. This forces brick-and-mortar retailers to search for more effective ways to attract new customers, to strengthen their loyalty, and ways to encourage fast decision making about the purchase. To solve these problems, brick-and-mortar shops has an aim to provide more personified offers to potential clients, formed during a very short period of time—the time while the sight of a customer passing by scans an advertising carrier.

Nowadays an advertising offer placed on stationary carriers in the points of human traffic accumulation is targeted also to a wide group of people with statistically “average” portrait of a customer of the given site. Moreover, the dataset for statistics is limited by information received through a survey of focus groups, traffic monitoring devices, sales area employees' feedbacks, etc. However, a range of decisive factors remains unused. These factors are important characteristics of a potential customer such as sex, age, mood, movement tracking history at the site. External conditions (weather, currency rate, data from electronic queues etc.) also play an important role. Creation of advertising taking into account these factors allows to form a unique offer for a specific potential customer. And this encourages making a decision on purchasing “here and now”, which is the target action of promotion activities. Absence of personified advertisement dramatically lowers sale conversion of all brick-and-mortar shops, leaving a huge number of unsatisfied needs for customers. This creates the reason for flow of sales volume to on-line marketplaces, which are already capable to optimize advertising for a specific user of the Internet.

### Conventional Art

Optimization of placement methods for relevant information on goods, promotions, sales, and other advertisement in brick-and-mortar retail is a field where entrepreneur's constant efforts are concentrated.

Nowadays digital technologies are gradually replacing traditional “static” advertising media such as paper price tags, standings, billboards etc. This is related to the fact that high-definition digital panels (LCD, LED, plasma monitors and televisions) allow to place more advertisements per unit time and provide fast and easy advertising change (U.S. Pat. No. 9,235,375B2 of 12.01.2016, US20140222578A1 of 07.08.2014). These factors are critical for placement of advertising media at sales areas with the highest customer traffic density (escalators in malls, ATMs, fuel stations, etc.).

However, such devices work only in the content demonstration mode and cannot adapt an advertisement to a specific viewer. Another drawback of these devices is the fact that it is difficult to receive data about actual efficiency of such advertising. HD panels don't have the technical capability to record how many persons have seen the advertisement, and also to represent statistics according to the age, sex, and other characteristics of customers.

There are known methods to acquire data about reaction of a person to viewing advertisements. Laptops, tablets, mobile phones contain microphones and video cameras capable to track face expression, eye motion patterns, recognize speech of the user during operation of different software applications. Such devices, besides high-resolution cameras, contain proximity detectors, accelerometers, and sensor screens (galvanic skin response), which also constantly track user's actions during mobile phone operation. Nowadays similar technologies are used in external advertising. Modern interactive advertising media (advertising panels) can include high-resolution cameras, which not only record the distance to the viewer, but also capable to recognize sex, age, face expression, sight direction (U.S. Pat. No. 8,996,510 of 31.03.2015). Moreover, such systems can contain detectors for mobile devices motion tracking through Wi-Fi MAC scanners for analysis of customer's movement trajectory over the sales area (US20200364730A1 of 19.11.2020).

However, these devices are not free form drawbacks. Monitoring of the audience (video analytics, face recognition, data processing by triggers) and control of broadcasting (which content is to be shown to which viewer) takes place entirely on servers, substantially remote from broadcasting devices (herein after referred to as broadcasting units). A broadcasting unit in such devices is responsible only for the terminal delivery of information and cannot calculate logics of content demonstration. As a consequence, such systems have large response time, what makes its application at sales areas with high customer traffic density difficult.

### DISCLOSURE OF THE INVENTION

The present group of inventions allows to update an advertising offer in real time, optimizing it for a specific viewer and external conditions (weather, currency rate, etc.). This is possible due to the fact that processing of sensor data (video cameras, Wi-Fi MAC scanners, microphones etc.) is performed directly in the broadcasting unit without transmission to remote servers. Moreover, due to integrated data processing effected by software algorithms in the broadcasting unit, reliability of estimation of delivered advertising efficiency increases, due to the fact that within the period of data processing and content change the visitor has no time to leave the area of sensitivity of system sensors.

### BRIEF DESCRIPTION OF DRAWINGS

Features and advantages of embodiments of the claimed subject matter will become apparent as the following Detailed Description proceeds, and upon reference to the Drawings, wherein like numerals depict like parts, and in which:

FIG. 1 illustrates a system block diagram of an advertisement management system consistent with an embodiment of the present disclosure.

Although the following Detailed Description will proceed with reference being made to illustrative embodiments, many alternatives, modifications, and variations thereof will be apparent to those skilled in the art.

FIG. 1 illustrates a block diagram of an advertising management system 100 consistent with an embodiment of the present disclosure. The advertising management system 100 includes the content demonstration request unit 101, the database 102, the broadcasting unit 103, the information output device 104, the visitor's data acquisition device 105, the analyzing and processing unit 106, and external data sources 107.

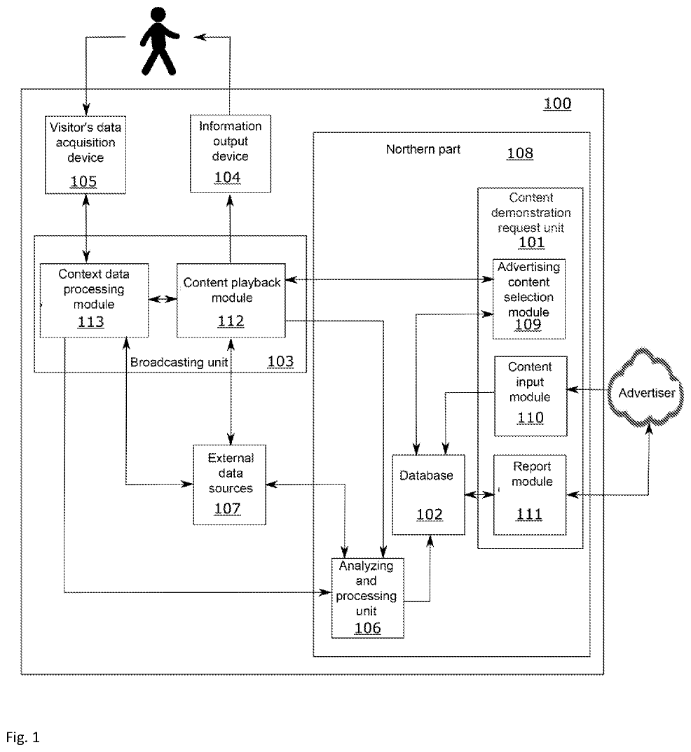

The content demonstration request unit 101, the database 102, and the analyzing and processing unit 106 are located in the server part 108. The server part 108 in the basic embodiment of the system 100 is located at remote servers and is out of the sales area at an external site relative to the place of visitor traffic gathering.

The content demonstration request unit 101 includes the advertising content selection module 109, the content input module 110 and the report module 111.

At the same time the advertising content selection module 109, the content input module 110 and the report module 111 are connected to the database 102, which is connected to the analyzing and processing unit 106.

As the content input module 110, CMS, CRM, a personal area, a service, API, etc., or software method for information input with a user's interface may be used.

The report module 111 may contain algorithms generating a report for the ordering customer (advertiser) or an outside system, an analytical system, a recommendation system, a client for the database with algorithms of generation XLS, XLSX, PDF, XML, JSON etc. formats of data output, or as plots in the form of vector graphics or image.

The broadcasting unit 103, the information output device 104 and the visitor's data acquisition device 105 are located in the zone of visitor traffic gathering (for example, at the sales area, in a shopping mall, sporting event zone, etc.).

The broadcasting unit 103 includes the content playback module 112, the context data processing module 113.

The content playback module 112 and the context data processing module 113 are connected to the analyzing and processing unit 106. At the same time the content playback module 112 is additionally connected to the advertising content selection module 109.

In one of embodiments of the system 100 the advertising content selection module 109 can be implemented as a software component, which effects data exchange upon request with the content playback module 112 (the requesting component). The request may be done as a function call, REST-request or in another way, obvious for a person skilled in the art. The advertising content selection module 109, according to information from the content playback module 112 (tokens or other descriptors), interacts with the database 102 (SQL requests, program interface calls, etc.) for receiving and structuring information about the advertising content, represented as text lines, media files, images, video data etc., as well as a link to the content. At the output, information containing advertising content is transferred to the requesting component. These can be structured data in XML, JSON, VAST, etc. formats. Also, the data may contain links to media files and parameters indicating how exactly the content should be interpreted or played back.

The content playback module 112, the context data processing module 113 and the analyzing and processing unit 106 are connected to external data sources 107.

As external data sources 107, services providing data about weather, currency rates, as well as CRM systems, warehouse systems, cash register data, etc. may be used.

The content playback module 112 is connected at least to one information output device 104 and to the context data processing module 112, which is connected at least to one visitor's data acquisition device 105.

The broadcasting unit 103 can be implemented as a system unit, an industrial computer, a nettop and similar computers, with provided broadband data transfer to every visitor's data acquisition device 105, which can be implemented in the form of a video camera, Wi-Fi MAC scanner, microphone, and similar sensors.

At the same time different visitor's data acquisition devices 105 may have significantly different operation distance, and the context data processing module 112 may provide different processing rate of data from corresponding devices. For example, registration of changes in the video stream (appearance of new visitors in the frame, change of the face expression etc.) can be done every second at a distance of several meters, while check of Wi-Fi MAC addresses of mobile devices can be done once in 10 seconds within a radius of dozens of meters, which depends on technical peculiarities of detection and data filtration by modern signal and image processing algorithms.

The information output device 104 can be implemented as an LCD, LED, plasma monitor, television, radio signal transmitter, network data transmitter, loudspeakers etc.

### DETAILED DESCRIPTION OF THE INVENTION

According to the present group of inventions the advertiser submits an application for demonstration of advertising to the visitors of a sales area, a shopping mall, sporting event zone, exhibition, and other zones of gathering of potential clients' traffic. In the application the advertiser specifies a set of rules for advertising content demonstration, and a corresponding set of advertising materials. The application is uploaded to the server part 108 of the system 100 through the content input module 110 of the content demonstration request unit 101 and saved in the database 102.

The advertiser can be a person or an outside software system working at external servers.

As the rules for advertising content demonstration, the application can contain a list of conditions, at which the advertising content should be demonstrated, and/or combination thereof. For example, there can be specified parameters and characteristics of target viewers (sex, age, mood), environment parameters (outdoor air temperature, presence of rain, day of week, season, etc.), requirements for recording general characteristics of the target audience at the site (children's center, shopping mall, brand shopping and exhibition center), load of the site, etc. For example, in the application it can be specified that a soft drink advertisement must be shown only in hot weather (at a temperature higher than +26° C.) for persons younger than 35 years old.

In the application for every rule there can be a price for demonstration or a price for viewing, as well as demonstration priority, which is used when other conditions are equal. For example, a woman with a child can be considered in the application, according one of the rules, as a woman to which a body care product advertisement must be shown. According to another rule, the same woman can be considered as the mother of the child, to which a childcare product advertisement must be shown.

After uploading of the application in the system 100 the advertising content selection module 109 transfers all materials necessary for execution of the application from the database 102 to the content playback module 112 of the broadcasting unit 103. In case of uploading of an updated version of the application into the database 102, the advertising content selection module 109 provides quick update of the advertising content in the broadcasting unit 103. At the same time the database 102 is also located in the server part 108 of the system 100, while the broadcasting unit 103 is located in the proximity to the visitors but may be hidden from visitor's sight for keeping aesthetics of the design solutions of the room of the site.

In one embodiment the system 100 has several broadcasting units 103 at a site, with visitor's data acquisition devices and information output devices 104 connected to them. Broadcasting units 103 are connected between each other in a data transfer network. Integration of broadcasting units 103 in the network allows to track the visitor's movement trajectory during his or her staying in the site, and precise the advertising offer based on previous advertising content demonstration history.

The broadcasting unit 103 continuously scans the visitors around the broadcasting unit 103 by means of at least one visitor's data acquisition device 105 (sensors of different type), and the acquired data set from output of the sensors (video stream, Wi-Fi MAC scanner data traffic, microphone signal, etc.) is transferred to the context data processing module 113 of the broadcasting unit 103.

The data from visitor's data acquisition devices are processed by information processing algorithms in context data processing module 113. Without departing from the spirit of the invention, any suitable processing algorithms of data from corresponding sensors (image and signal processing algorithms, video analytics, classification, facial and speech recognition, etc.), data merging technologies for data from multisensor systems (data fusion algorithms for multisensor systems), multi-modal object tracking in a network of different sensors, etc. can be used for processing. The result of such processing is detection of visitors in the field of view of the sensors, recognition of visitor's attributes (sex, age, concentration, mood, etc.) for classifying each visitor according to a set of features, specified in the rules for advertising content demonstration. Data from external data sources 107 can be considered during processing, for example, illumination parameters, room configuration, escalator speed, length of queues, etc. When broadcasting units 103 are integrated in the network for increase of processing rate of the system 100, between two nodes of the network only final result of visitor classification (for example, sex, age, mood) can be transferred, as well as the history of movement of the visitor in the room within the range of sensitivity area of the sensors of visitor's data acquisition device 105 of a specific node of the network (a separate broadcasting unit 103).

During data processing, the context data processing module 113 transfers the result of processing to the content playback module 112, in which the processing result is joined to the data from external data sources 107.

Thus, besides visitor's data (sex, age, mood, etc.) for execution of the application, environment data, actual situation on the site of the sales area (density of human traffic, queue length at the cash desk), common information background (currency panic, big sporting events, etc.) can be used. For example, when a person belonging to an age-sex group defined by the advertiser approaches the visitor's data acquisition device during the rain, the system 100 demonstrates an umbrella advertisement. If the visitor is with children, child umbrellas can be offered. Offered models and colors of umbrellas may vary according to the sex and age of potential viewers.

The content playback module 112 selects a rule from the set of the rules for advertising content demonstration, which coincides the most closely to the results of classification, taking into account information from external data source 107, then it launches demonstration of advertising materials corresponding to the selected rules through information output devices 104.

If the application contains the price of demonstration, viewing and/or priority of a certain rule, the most expensive rule of the application is chosen for demonstration. If several rules of the maximum price are suitable, a rule can be selected according to maximum priority.

Information on advertising content choice result can be transferred back to the advertising content selection module 109 for completion of demonstration statistics data, and demonstration reporting for subsequent forecasting for new applications.

Thus, in one embodiment of the system the content playback module 112 performs downloading and caching of the content, media file decoding, evaluating of an actual media plan (based on the uploaded set of rules of the application, it makes a decision, which content must be demonstrated at every time moment), preparing the content for playing back, rendering and playback through information output device 104. Thus, the system 100 adapts the advertising content (selects the most expensive, preferential, and suitable according to the application rules), taking into account all the audience in the field of view of the sensors.

Simultaneously with demonstration of advertising materials the broadcasting unit 103 performs registration of viewing of advertising material by a visitor by data processing, at least from one visitor's data acquisition device 105. Acquired data are transferred to the analyzing and processing unit 106 located in the server part 108 of the system 100 and saved as a tag about viewing the content by the viewer(s) in an anonymous form (personal data are ignored by the system). At the moment of data acquisition from the broadcasting unit 103 the analyzing and processing unit 106 registers environment parameters, acquired from external data sources 107. This information can be used for specifying viewing statistics, for taking into account not only the number of viewings of advertising materials, but also data about weather, a day of week, presence of buying fever at the site at the moment of advertising content demonstration, etc.

The analyzing and processing unit 106 transfers and saves information about viewing in the database 102 as a tag about changes in demonstration indicators, accomplishment of a demonstration quantitative target of the application, registration of historical and analytical data.

Upon the request of the advertiser, the report module 111 located in the content demonstration request unit 101 performs compilation of a report about accomplishment of planned demonstration quantitative targets specified in the application, which is presented to the advertiser for efficiency analysis of advertising offer management. The report can be supplemented by forecasted indicators, demonstration history maxima and/or minima, recommendations for improvement of advertising quantitative targets.

Thus, the present group of inventions allows to update an advertising offer in real time, optimizing it for a specific viewer (age-sex characteristics, mood, movement trajectory over the sales area etc.) and external conditions (weather, currency rate, day of week, queue length, etc.). This is possible due to the fact that processing of sensor data (video cameras, Wi-Fi MAC scanners, external data sources) is performed directly in the broadcasting units 103 without data transmission to the server part 108 at remote servers. Downloading of advertising materials and content demonstration rules from the database 102 located in the server part 108, to the broadcasting unit 103 located directly at the site of human traffic gathering, is done in advance, before visitor scanning starts. The broadcasting unit 103 in the present group of inventions is capable to make decision on content demonstration itself. This reduces response time of the system 100 and makes possible its use at sites with high traffic density of potential customers. Moreover, due to integrated information processing effected by software algorithms directly in the broadcasting unit 103 (locally, without addressing to the server part 108), reliability of estimation of delivered advertising content efficiency increases, as within the period of data processing and content change the visitor has no time to leave the area of sensitivity of system sensors.

1. A system for advertising content demonstration management, the system comprising:
a content demonstration request unit;
a database;
a broadcasting unit;
an information output device;
at least one visitor's data acquisition device;
an analyzing and processing unit; and
external data sources, wherein
the content demonstration request unit, the database, and the analyzing and processing unit are located in a server part,
the broadcasting unit, the information output device or interaction device which could be perceived/used by visitor or by the visitor's accessories, and the at least one visitor's data acquisition device are located in a zone of visitor traffic gathering, the zone of visitor traffic gathering located separate from the server part,
the content demonstration request unit includes an advertising content selection module, a content input module, and a report module,
the broadcasting unit includes a content playback module and a context data processing module, the broadcasting unit configured for deciding, without data transmission to the server part, which advertising materials to demonstrate in the zone of visitor traffic gathering,
the advertising content selection module, the content input module and the report module are connected to the database, which is connected to the analyzing and processing unit,
the analyzing and processing unit is additionally connected to the context data processing module and to the content playback module, which is connected to the advertising content selection module,
the content playback module, the context data processing module and the analyzing and processing unit are connected to external data sources,
the content playback module is connected to the information output device and to the context data processing module, which is connected to the at least one visitor's data acquisition device, and
in the broadcasting unit, the context data processing module is configured for processing data from the at least one visitor's data acquisition device, the at least one visitor's data acquisition device and the broadcasting unit all located in the zone of visitor traffic gathering separate from the server part.

2. The system according to claim 1, wherein
the zone of visitor traffic gathering being a sales area, in a shopping mall, or a sporting event zone.

3. A method for advertising content demonstration management, the method comprising:
compilation of a set of rules for advertising content demonstration, and a corresponding set of advertising materials;
saving of the set of advertising materials in a database, the database located in a server part;
scanning of visitors around a broadcasting unit, by at least one visitor's data acquisition device, the broadcasting unit and the at least one visitor's data acquisition device located in a zone of visitor traffic gathering, the zone of visitor traffic gathering located separate from the server part;
recognition and classifying, by a context data processing module in the broadcasting unit, of visitors according to data acquired, taking into account information from external data sources;
selecting a rule, by a content playback module in the broadcasting unit, from a set of the rules for advertising content demonstration, which coincides the most closely to the results of said classification, taking into account information from external data source;
deciding, by the broadcasting unit without data transmission to the server part, which advertising materials to demonstrate, in the zone of visitor traffic gathering, corresponding to the selected rule;
demonstration of said advertising materials corresponding to the selected rule;
registering of viewings of advertising materials by a visitor by means of at least one visitor's data acquisition device;
saving information about viewings in the database located in the server part; and
compilation of a report about accomplishment of planned demonstration quantitative targets specified in an application.

4. A non-transitory computer readable medium having instructions stored thereon, such that when the instructions are read and executed by one or more processors, said one or more processors is configured to perform a method comprising the steps of:
compilation of a set of rules for advertising content demonstration, and a corresponding set of advertising materials;
saving of the set of advertising materials in a database, the database located in a server part;
scanning of visitors around a broadcasting unit, by at least one visitor's data acquisition device, the broadcasting unit and the at least one visitor's data acquisition device located in a zone of visitor traffic gathering, the zone of visitor traffic gathering located separate from the server part;
recognition and classifying, by a context data processing module in the broadcasting unit, of visitors according to data acquired, taking into account information from external data sources;
selecting a rule, by a content playback module in the broadcasting unit, from a set of the rules for advertising content demonstration, which coincides the most closely to the results of said classification, taking into account information from external data source;
deciding, by the broadcasting unit without data transmission to the server part, which advertising materials to demonstrate, in the zone of visitor traffic gathering, corresponding to the selected rule;
demonstration of said advertising materials corresponding to the selected rule;
registering of viewings of advertising materials by a visitor by means of at least one visitor's data acquisition device;
saving information about viewings in the database located in the server part; and
compilation of a report about accomplishment of planned demonstration quantitative targets specified in an application.

5. The system according to claim 1, wherein
the server part is located at one or more remote servers.

6. The system according to claim 1, wherein
the at least one visitor's acquisition device comprises a plurality of visitor's acquisition devices located in the zone of visitor traffic gathering.

7. The system according to claim 6, wherein
in the broadcasting unit, the context data processing module is configured for processing data from the plurality of visitor's data acquisition devices located in the zone of visitor traffic gathering.

8. The system according to claim 1, further comprising:
one or more additional broadcasting units located in the zone of visitor traffic gathering, wherein all the broadcasting units are integrated in a data transfer network for increasing processing rate of the system.

9. The system according to claim 1, wherein
the at least one visitor's data acquisition device is configured for scanning visitors around the broadcasting unit, and
the broadcasting unit is configured for downloading advertising materials or content demonstration rules from the database located in the server part before visitor scanning is performed by the at least one visitor's data acquisition device.

10. The system according to claim 1, wherein
the broadcasting unit is configured for making decision on content demonstration itself.

11. The method according to claim 3, wherein
the zone of visitor traffic gathering being a sales area, in a shopping mall, or a sporting event zone.

12. The method according to claim 3, wherein
the at least one visitor's acquisition device comprises a plurality of visitor's acquisition devices located in the zone of visitor traffic gathering.

13. The method according to claim 12, wherein the step of recognition and classifying of visitors comprises:
recognition and classifying, by the context data processing module in the broadcasting unit, of visitors according to data acquired from the plurality of visitor's data acquisition devices located in the zone of visitor traffic gathering, taking into account information from external data sources.

14. The method according to claim 3, further comprising:
integrating the broadcasting unit with one or more additional broadcasting units located in the zone of visitor traffic gathering in a data transfer network for increasing processing rate of a system.

15. The method according to claim 3, further comprising:
downloading, by the broadcasting unit, advertising materials or content demonstration rules from the database located in the server part before visitor scanning is performed by the at least one visitor's data acquisition device.

16. The non-transitory computer readable medium according to claim 4, wherein
the zone of visitor traffic gathering being a sales area, in a shopping mall, or a sporting event zone.

17. The non-transitory computer readable medium according to claim 4, wherein
the server part is located at one or more remote servers.

18. The non-transitory computer readable medium according to claim 4, wherein
the at least one visitor's acquisition device comprises a plurality of visitor's acquisition devices located in the zone of visitor traffic gathering.

19. The non-transitory computer readable medium according to claim 18, wherein the step of recognition and classifying of visitors comprises:
recognition and classifying, by the context data processing module in the broadcasting unit, of visitors according to data acquired from the plurality of visitor's data acquisition devices located in the zone of visitor traffic gathering, taking into account information from external data sources.

20. The non-transitory computer readable medium according to claim 4, the method further comprising:
downloading, by the broadcasting unit, advertising materials or content demonstration rules from the database located in the server part before visitor scanning is performed by the at least one visitor's data acquisition device.
